(19) United States
(12) Patent Application Publication
(10) Pub. No.: US 2004/0154876 A1
(43) Pub. Date: Aug. 12, 2004

(54) Apparatus for equalizing tension of main ropes of elevator

(76) Inventor: Jeong-Du Choi, Ulsan (KR)

Correspondence Address: DR. MARK FRIEDMAN LTD., C/o Bill Polkinghom, Discovery Dispatch, 9003 Florin Way, Upper Marlboro, MD, 20772, US

(21) Appl. No.: 10/747,119

(22) Filed: Dec. 30, 2003

(30) Foreign Application Priority Data
Jan. 11, 2003 (KR) 2003/1885
May 28, 2003 (KR) 2003/33928

(51) Int. Cl. B66B 7/10; B66B 7/08

(52) U.S. Cl. 187/412; 187/411

(57) ABSTRACT

Disclosed is an apparatus for automatically equalizing tension of main ropes of an elevator suspended to the main ropes so as to move up and down. A structure of the apparatus is simplified so that the apparatus is easily fabricated and installed with improving a tension equalizing function. The apparatus has a plurality of movable pulleys coupled with ends of the main ropes, which are coupled to a car or a count weight and aligned in a machine room or a hoistway, through rods and rope coupling members, a fixed pulley section supported by a beam and having a plurality of fixed pulley sheaves installed in a single block in a longitudinal direction of the single block, a compensating rope aligned between the movable pulleys and the fixed pulley section so as to allow the movable pulleys to move depending on tension of main ropes coupled with the movable pulleys, and a housing for properly positioning the above components. The apparatus is easily manufactured, conveyed and installed while completely solving uneven tension of the main ropes, thereby reducing labor force required for managing the elevator.

### FIELD OF THE INVENTION

The present invention relates to an apparatus for equalizing tension of ropes of an elevator, and more particularly to an apparatus for automatically equalizing uneven tension of ropes of an elevator, which is suspended to a plurality of ropes in order to move Up and down.

### DESCRIPTION OF THE PRIOR ART

Among terms described in the following description, a “rope coupling member” consists of a rope socket, a thimble rod, a damping spring, a spring seat, a turnbuckle, a nut, and a split pin, or consists of some of the above components, which are generally used for coupling ropes.

A “beam” signifies a beam provided in a hoistway or a machine room, in which ropes are aligned, or beams of a car or a count weight.

A “compensating rope” means a rope aligned between a movable pulley and a fixed pulley in order to control the movable pulley, to which load is applied from main ropes.

A “compensating chain” means a chain aligned between a movable geared pulley and a fixed geared pulley in order to control the movable geared pulley, to which load is applied from main ropes.

In an elevator or the like having a plurality of ropes for supporting load, if a length difference exists between ropes, the ropes are subject to uneven tension because load is unevenly applied to the ropes. When the elevator is initially established or when ropes are exchanged, it is difficult to precisely match the lengths of the ropes with each other due to a bending structure and rigidity of the wire ropes, so the length difference of the ropes occurs. In addition, the length difference of the rope is created due to a misalignment of equipment providing tension to the ropes. Besides, the length difference of the ropes is derived from a differential expansion rate of the ropes, a fault of sheave material or rope material, and eccentric load applied to a car. Due to the length difference, the ropes having relatively short lengths are subject to over-tension so that wires of the wire ropes are rapidly worn. In addition, the ropes having relatively short lengths are easily deformed or broken while causing early wear of sheave grooves, so it is required to frequently exchange the ropes and sheaves. Furthermore, due to unbalanced load between the ropes, vibration is generated from the ropes in longitudinal and transverse directions. This vibration is directly transferred to the car, so passengers in the car may feel uneasy. The above situation is similar to a situation of a vehicle having an inferior wheel alignment, which shortens a life span of related components including tires and deteriorates steering performance and riding comport.

Although various techniques have been suggested to solve uneven tension of the ropes, most of them relate to a device for damping vibration generated from the ropes, a device for blocking vibration transferred from the ropes, a device for measuring uneven tension of the ropes or uneven wear of the sheave grooves, and a device for easily adjusting tension of the ropes. That is, the above techniques manually adjust tension of ropes, so they have problems as follows:

a) since a work for checking uneven tension of the ropes is carried out in a machine room or from an upper portion of the car, which is separated from a passageway, it is cumbersome for workers to frequently check uneven tension of the ropes.

b) as mentioned above, since uneven tension of the ropes mainly occurs when establishing the elevator or when exchanging the ropes or related components thereof, it is difficult to precisely adjust tension of the ropes even if uneven tension of the ropes is detected.

c) even if uneven tension of the ropes is precisely adjusted, uneven tension of the ropes may generate again due to a structural problem.

d) uneven tension of the ropes is not found until great amount of uneven tension occurs.

e) a worker cannot precisely feel uneven tension of the ropes because the ropes having shorten lengths tend to be lengthened while promoting wear of sheave grooves, through which the ropes passes.

In order to solve the above problems, it is required to provide techniques capable of adjusting tension of the ropes in real time. Examples of the techniques capable of adjusting tension of the ropes in real time are disclosed in Japanese Patent laid-open publication No. 5-39181, U.S. Pat. No, 6,223,862, and Korean Patent laid-open publication No. 2001-0069291, which is filed by an applicant of the present invention. However, a fluid-type apparatus may cause a fluid-leakage and generate resistance in a packing portion for sealing the fluid-leakage so that the fluid-type apparatus cannot completely solve uneven tension of the ropes. In addition, a tackle-type apparatus may cause resistance due to an angle of repose between a tackle and a wall surface, so the tackle-type apparatus cannot effectively solve uneven tension of the ropes.

### SUMMARY OF THE INVENTION

Therefore, the present invention has been made in view of the above-mentioned problems, and it is an object of the present invention to provide an apparatus for equalizing tension of main ropes of an elevator. The apparatus mainly includes sheaves and compensating ropes without requiring a large installation space for the sheaves and compensating ropes and a cumbersome work for installing the sheaves and compensating ropes, while removing disadvantages of various components menacing safety, so that the apparatus can be safely and easily applied to a beam of the elevator installed in a narrow space.

To accomplish the above object, the present invention provides an apparatus for equalizing tension of main ropes of an elevator suspended to the main ropes so as to move up and down, the apparatus comprising a plurality of movable pulleys coupled with ends of the main ropes coupled to a car or a count weight and aligned in a machine room or a hoistway, a fixed pulley section supported by a beam, a compensating rope aligned between the movable pulleys and the fixed pulley section, and a housing for properly positioning the above components.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing an apparatus for equalizing tension of main ropes of an elevator according to one embodiment of the present invention;

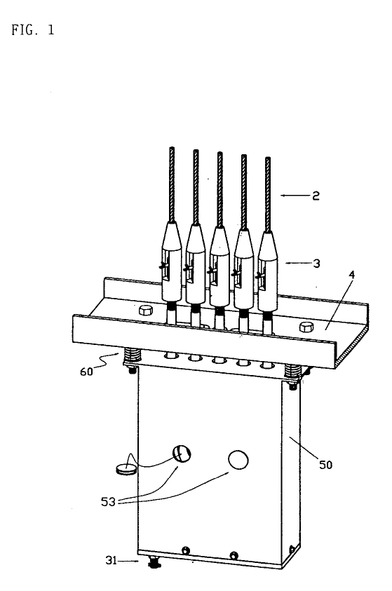

FIG. 2 is a partially sectional perspective view showing main components of the apparatus shown in FIG. 1.

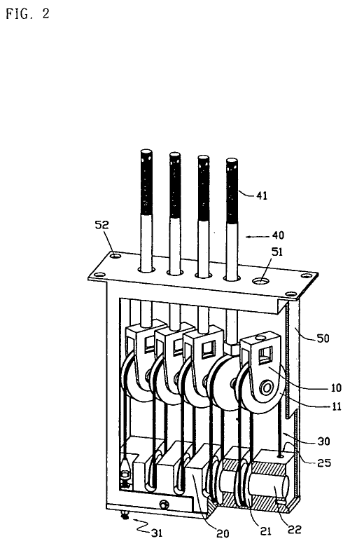

FIG. 3 is a sectional perspective view showing a length difference between main ropes shown in FIG. 1;

FIG. 4 is a plan view showing an alignment of pulleys shown in FIG. 1 according to one embodiment of the present invention;

FIG. 5 is a plan view showing an alignment of pulleys according to another embodiment of the present invention; and

FIGS. 6 and 7 are perspective view showing an apparatus for equalizing tension of main ropes of an elevator according to another embodiments of the present invention.

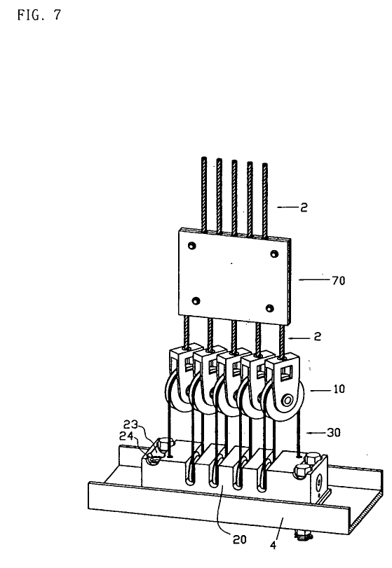

### DETAILED DESCRIPTION OF THE PREFERRED EMBODIMENTS

Reference will now be made in detail to the preferred embodiments of the present invention.

In the following description of the present invention, a detailed description of known functions and configurations incorporated herein will be omitted when it may make the subject matter of the present invention rather unclear.

### Embodiment 1

Generally, main ropes 2 of an elevator are directly coupled to a beam 4. An apparatus for equalizing tension of the ropes 2 according to one embodiment of the present invention includes a plurality of movable pulleys 10, which are coupled to the main ropes 2 through rope coupling members 3 and rods 40, and a fixed pulley section 20 supported by the beam 4 and having a plurality of fixed pulley sheaves 21 installed in a single block and a compensating rope supporting section 25. A compensating rope 30 is aligned between the-movable pulleys 10 and the fixed pulley section 20 while being supported by the fixed pulley section 20 in such a manner that the movable pulleys 10 can move up and down depending on tension of the main ropes 2 applied to the movable pulleys 10. A housing 50 is provided to align the above components in proper positions. The housing 50 is formed at an upper surface thereof with rod holes 51 for receiving the rods 40. Couplings holes 52 are formed at both sides of the upper surface of the housing 50 so as to allow the housing 50 to be coupled with the beam 4. Inspection holes 53 are formed at one surface of the housing 50 in order to allow a worker to check an interior of the housing 50. A plurality of damping members 60 are provided between the beam 4 and the housing 50 so as to protect components including the compensating rope 30 from sudden acceleration or deceleration of the elevator. A rope guide 70 is provided to prevent lengths of the ropes 2 from being relatively varied with each other according to an operation (up/down movement) of the elevator. To this end, the rope guide 70 is formed with a plurality of curved holes corresponding to the main ropes 2. Intervals between the curved holes at an upper surface of the rope guide 70 are identical to intervals between the movable pulleys 10. In addition, intervals between the curved holes at a lower surface of the rope guide 70 are identical to intervals between sheave grooves.

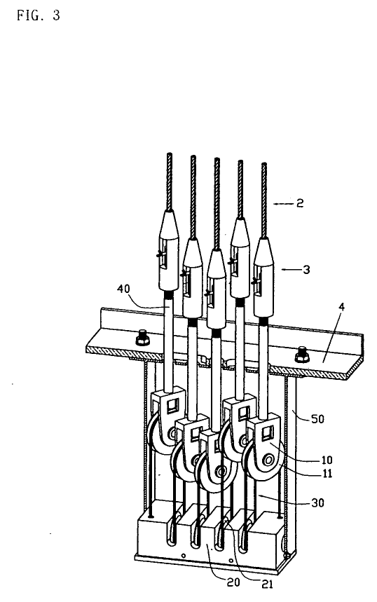

FIG. 3 is a sectional perspective view showing a length difference between main ropes 2, a principle of which can be easily understood by persons having a concept of kinematics. Referring to FIG. 3, the main ropes 2 are supported by the compensating rope 30 through the rope coupling members 3, rods 40 and the movable pulleys 10. In this state, if a relative length difference occurs between main ropes 2, the compensating rope 30 is subject to uneven tension so that the movement of the compensating rope 30 and rotation of sheaves may simultaneously occur, thereby compensating for the relative length difference between the main ropes 2. A relationship between the sheaves and the compensating ropes is similar to that of a balance and an object. That is, even if a little amount of uneven tension occurs in the compensating ropes, the sheaves carry out a balancing action regardless of an amount of load applied to the compensating ropes. This, the compensating ropes and the sheaves are effective in a functional aspect.

In addition, in order to compensate for a displacement caused by the relative length difference of the main ropes 2, first sides of the rods 40 are formed with elongated screw sections and second sides of the rods 40 are rotatably coupled to the movable pulleys 10 for preventing the main ropes 2 from being twisted.

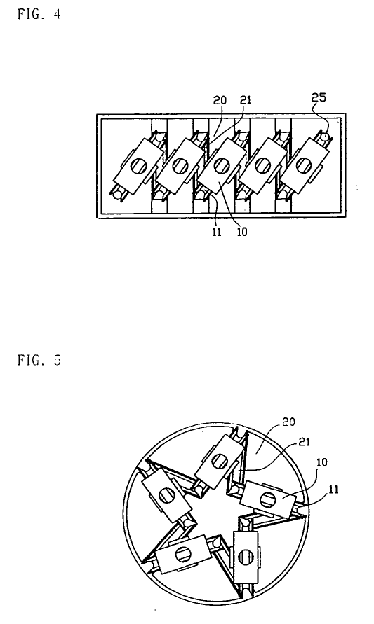

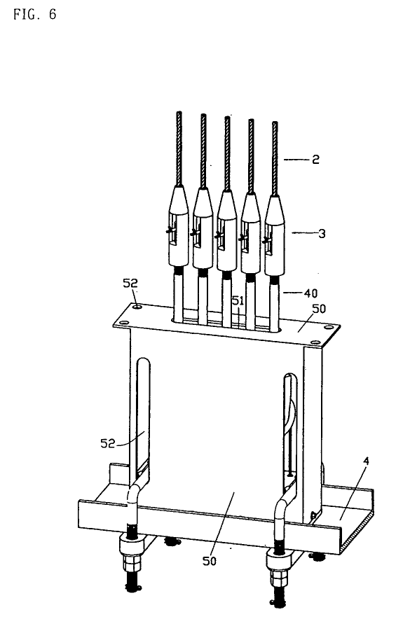

As shown in FIGS. 4 and 5, movable pulley sheaves 11 are preferably offset from fixed pulley sheaves 21 in such a manner that the compensating rope 30 aligned between movable pulley sheave grooves and fixed pulley sheave grooves is parallel to a moving direction of the main ropes 2.

In addition, the fixed pulley section 20 is formed at predetermined portions thereof with a groove 23 and a perforation hole 24 for allowing the fixed pulley section 20 to be supported by the beam 4. A coupling hole is formed at both sides of the fixed pulley section 20 in order to allow the fixed pulley section 20 to be securely coupled with the housing 50. When the apparatus for equalizing tension of the main ropes 2 is installed at a lower portion of the beam 4, a jaw section for supporting the housing is formed at a lower portion of the apparatus in such a manner that load of the apparatus is easily supported by the housing 50 when the apparatus is coupled with the housing 50. In addition, it is preferred to align the fixed pulley sheaves 21 in parallel to each other in a longitudinal direction of the single block or in a substantially longitudinal direction of the single block.

If the fixed pulley sheaves 21 are aligned as shown in FIG. 4, an end section is formed at the compensating rope 30. However, when the fixed pulley sheaves 21 are aligned as shown in FIG. 5, the end section is not formed. When the end section is formed in the compensating rope 30, at least one compensating rope fixing member 31 including a bolt and a nut is provided at the end section in order to deal with a length variation of the compensating rope 30.

When the car or the count weight approaches a driving sheave or a deflector, the rope guide 70 restricts the-variation of the relative length of the main ropes 2 caused by a difference between an interval of sheave grooves and an interval required for the rope coupling member 3 for coupling or supporting the main ropes 2, thereby preventing the movable pulley 10 from being frequently moved according to the operation of the elevator. In addition, the rope guide 70 allows the main ropes 2 to be densely aligned at a beam side.

According to the present invention, the movable pulleys 10 can be aligned in a linear or a circular pattern as shown in FIGS. 4 and 5. Although it is not illustrated, it is also possible to align the movable pulleys 10 in two or three rows, or in a lozenge pattern depending on an alignment of the fixed pulley sheaves. In addition, the present invention is not only adaptable for newly established elevators, but also adaptable for a conventional elevator system having the beam 4 formed with a plurality of coupling holes for coupling the main ropes 2. In addition, most components are aligned at a lower portion of the beam 4 by means of the housing 50,

### Embodiment 2

Different from the apparatus according to the first embodiment including the pulleys having sheaves and main ropes, the present embodiment mainly includes geared pulleys and a chain.

That is, even though it is not illustrated, the apparatus according to the second embodiment of the present invention includes movable geared pulley, a fixed geared pulley section, and a compensating chain instead of the movable pulleys 10, fixed pulley section 20 and compensating rope 30. As compared with the first embodiment, in which sheaves must have diameters greatly larger than a diameter of the compensating rope in order to prevent tensile strength of the compensating rope from being lowered, such construction of the second embodiment is advantageous in that the main ropes 2 can be densely aligned.

As can be seen from the foregoing, according to the present invention, since the apparatus mainly includes sheaves and ropes, load is evenly distributed, so that tension of the main ropes is effectively equalized. In addition, since sheaves of the pulleys are densely aligned in a longitudinal direction thereof, a volume of the apparatus can be reduced. Furthermore, since the structure of the apparatus is simplified, a manufacturing process thereof can be simplified. In addition, the apparatus can be easily installed in an elevator system, in which the main ropes are densely aligned, without requiring a special additional work.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

What is claimed is:

1. An apparatus for equalizing tension of main ropes of an elevator suspended to the main ropes so as to move up and down, the apparatus comprising:
a plurality of movable pulleys coupled with ends of the main ropes coupled to a car or a count weight and aligned in a machine room or a hoistway;
a fixed pulley section supported by a beam; and
a compensating rope aligned between the movable pulleys and the fixed pulley section so as to allow the movable pulleys to move depending on tension of main ropes coupled with the movable pulleys.

2. The apparatus as claimed in claim 1, wherein the movable pulleys are connected to the main ropes through rods and rope coupling members

3. The apparatus as claimed in claim 2, wherein the fixed pulley section includes a plurality of fixed pulley sheaves installed in a single block.

4. The apparatus as claimed in claim 3, further comprising a housing formed at an upper surface thereof with rod holes for receiving the rods.

5. The apparatus as claimed in claim 4, wherein the housing is formed with at least one inspection hole for allowing a user to check an interior of the housing.

6. The apparatus as claimed in claim 4, wherein when end sections are formed in the compensating rope, a compensating rope fixing member including a bolt and a nut is provided in at least one of the end sections in order to deal with a length variation of the compensating rope.

7. The apparatus as claimed in claim 3 or 4, wherein a damping member is provided between the beam and the housing so as to protect components including the compensating rope from sudden acceleration or deceleration of the elevator.

8. The apparatus as claimed in claim 3 or 4, further comprising a rope guide formed with a plurality of curved holes for guiding the main ropes in order to prevent lengths of the main ropes from being relatively varied caused by an operation of the elevator, intervals between the curved holes at an upper surface of the rope guide being identical to intervals between the movable pulleys and intervals between the curved holes at a lower surface of the rope guide being identical to intervals between sheave grooves.

9. An apparatus for equalizing tension of main ropes of an elevator suspended to the main ropes so as to move up and down, the apparatus comprising:
a plurality of movable geared pulleys coupled with ends of the main ropes by means of rods and rope coupling members, the main ropes being coupled to a car or a count weight and aligned in a machine room or a hoistway;
a fixed geared pulley section supported by a beam; and
a compensating chain aligned between the movable geared pulleys and the fixed geared pulley section.
